(19) United States
(12) Patent Application Publication
(10) Pub. No.: US 2015/0194068 A1
(43) Pub. Date: Jul. 9, 2015

(54) Learn To Play A Stringed Musical Instrument One String At A Time

(71) Applicant: Frank Angelo Lucido, Ojai, CA (US)

(72) Inventor: Frank Angelo Lucido, Ojai, CA (US)

(21) Appl. No.: 14/101,181

(22) Filed: Jan. 8, 2014

(51) Int. Cl. G09B 15/00; G10G 7/00

(52) U.S. Cl. CPC G09B 15/00; G10G 7/00

(57) ABSTRACT

“Learn To Play A Stringed Musical Instrument One String At A Time” is a method of instruction for the playing of stringed musical instruments comprising the removal of the strings, from the instrument at the beginning of the instruction and followed by the addition of the strings to the instrument, one at a time, progressively during the term of instruction utilizing tablature and sheet music written specifically for the number of strings being used on the instrument at any one time during the progression of the instructional lessons.

### CROSS REFERENCE TO RELATED APPLICATIONS

(Not Applicable)

### STATEMENT OF FEDERALLY SPONSERED RESEARCH/DEVELOPMENT

(Not Applicable)

### REFERENCE TO A “SEQUENCE LISTING,” a table or a computer program listing appendix submitted on a compact disc and an incorporation by reference of the material on the compact disc including duplicates and the files on each compact disc shall be specified.

(Not Applicable)

### BACKGROUND OF THE INVENTION

I developed the teaching method I call “Learn To Play A Stringed Musical Instrument On String At A Time” over a 40 year period of time as a teacher of guitar, bass, and other stringed musical instruments. It is completely my own invention and to my knowledge, is not used by any other instructor.

### BRIEF SUMMARY OF THE INVENTION

“Learn To Play A Stringed Musical Instrument One String At A Time” is a teaching method I use for stringed musical instruments like the guitar, bass, banjo, mandolin or violin to name a few. I have the student remove the strings from their instrument at the beginning of the lesson and we learn the instrument literally one string at a time. Over the course of instruction, the student learns to play the instrument with music and/or tablature designed to instruct him while playing on one or more strings progressively, on up to the full number of strings on the particular instrument.

### BRIEF DESCRIPTION OF THE SEVERAL VIEWS OF THE DRAWING

(Not Applicable)

### DETAILED DESCRIPTION OF THE INVENTION

“Learn To Play A Stringed Musical Instrument One String At A Time” is an instructional method I invented for teaching students how to play stringed musical instruments. My method is unique in that I teach students how to play a musical instrument by first removing all the strings from the instrument and then adding them back on to the instrument, one string at a time, progressively over the course of the instructional period. My method utilizes tabalature and written music that is tailored to the number of strings that are on the musical instrument during the course of the lessons. For example, if I am teaching guitar, I begin by having the student remove all the strings from the instrument except the “E” or 6^{th} bass string. Then I start the student off on lesson one, with music and/or tablature that is designed to be played only on the “E” or 6^{th} bass string of the guitar. In lesson two, I ask the student to add the “A” or 5^{th} string on to the guitar and then I provide music and/or tablature that is designed to be played on both the 5^{th} and 6^{th} strings together. The idea behind this method is that by reducing the number of strings on the instrument down to their most basic configuration, I have also reduced the complexity of the instrument both physically and psychologically, to the the point that the novice, or beginning player can master the techniques and skills more easily and with more confidence. The student is able to learn an initial skill on one or two strings and then accumulate and apply more skills in each progressive lesson as additional strings are added. In this way, the learning process is less intimidating and the physical requirements are less demanding at the most critical time—namely during that period when the student is most unfamiliar with the instrument.

I assert that my system of progressively adding strings one at a time while providing instructional tablature or sheet music designed to be played on single or multiple strings of an instrument is unique and patentable.

1. A method of instruction for the playing of stringed musical instruments comprising the removal of the strings from the instrument at the beginning of the instruction and followed by the addition of the strings to the instrument, one at a time, progressively during the term of instruction utilizing tablature and sheet music written specifically for the number of strings being used on the instrument at any one time during the progression of the instructional lessons.
1. I claim exclusive right to this method of instruction for the playing of stringed musical instruments which removes any strings from the musical instrument.
2. I claim exclusive right to this method of instruction for the playing of stringed musical instruments which adds strings to the musical instrument during the progressive course of instruction.
3. I claim exclusive right to this method of instruction for the playing of stringed musical instruments which includes sheet music and/or tablature written for individual strings of the instrument or a combination thereof which totals less than the total number of strings normally featured on the instrument.
4. I claim exclusive right to this method of instruction for the playing of stringed musical instruments which includes individualized lessons on each of the strings of the musical instrument or combination thereof, as they are progressively added on to the instrument during the course of instruction.
